(19) United States
(12) Patent Application Publication
(10) Pub. No.: US 2015/0142895 A1
(43) Pub. Date: May 21, 2015

(54) Real Life Presence and Dynamic Meeting Scheduling

(71) Applicant: Microsoft Corporation, Redmond, WA (US)

(72) Inventors: Bora Beran, Bothell, WA (US); Paul Henry Dietz, Redmond, WA (US); Kori Marie Quinn, Redmond, WA (US)

(73) Assignee: Microsoft Corporation, Redmond, WA (US)

(21) Appl. No.: 14/081,731

(22) Filed: Nov. 15, 2013

(51) Int. Cl. H04L 12/58

(52) U.S. Cl. CPC H04L 51/04
USPC 709/206

(57) ABSTRACT

Various embodiments provide solutions that enable accurate tracking of users' statuses to provide real life presence information. The real life presence information can be used to enable meetings to be dynamically scheduled, thus making efficient use of a user's time and resources.

### BACKGROUND

Meetings can be an important part of life, particularly an individual's professional life. Calendar items with reminders and information, such as meeting location and a list of participants, have been a core component of office productivity suites for many years. Unified communications applications rely on calendar information to reflect individual's status (e.g., busy, available etc.).

However, real life schedules can be much more dynamic than what can be described by a rigid list of organized meetings and the associated information that appears in an individual's calendar.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments provide solutions that enable accurate tracking of users' statuses to provide real life presence information. The real life presence information can be used to enable meetings to be dynamically scheduled, thus making efficient use of a user's time and resources.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation in accordance with one or more embodiments.

FIG. 2 is an illustration of a system in an example implementation showing FIG. 1 in greater detail.

FIG. 3 is an illustration of a system in an example implementation in accordance with one or more embodiments.

FIG. 4 is a flow diagram that describes steps in a method in accordance with one or more embodiments.

FIG. 5 is a flow diagram that describes steps in a method in accordance with one or more embodiments.

FIG. 6 illustrates an example computing device that can be utilized to implement various embodiments described herein.

### DETAILED DESCRIPTION

Overview

Various embodiments provide solutions that enable accurate tracking of users' statuses to provide real life presence information. The real life presence information can be used to enable meetings to be dynamically scheduled, thus making efficient use of a user's time and resources.

In various embodiments, a system enables reporting fine-grained status (presence/availability) updates, referred to as “real life presence”, and use of this information to accurately reflect meeting participation and for matchmaking between parties who want to have a meeting. According to various approaches, status updates do not just rely on what a user's calendar looks like, e.g., an event takes place between 1-2 PM. Rather, the system also takes advantage of various types of location information, e.g. a user joined the meeting room at 1 P.M. and left the meeting room at 1:30 P.M.

To achieve this, in at least some embodiments, the system can leverage various different technologies that ascertain or approximate location depending on particular device and network capabilities and/or in-room meeting presence using, by way of example and not limitation, audio and facial recognition which are fully automated and do not have the user take any explicit action, as described below in more detail. In at least some embodiments, users can, however, sign in and out of meetings explicitly if other options are not available.

The use of real life presence can not only improve an online meeting experience by providing a better representation of the people physically attending the meeting, but it can also help identify gaps in individuals' schedules more accurately than static calendar entries, thus taking better advantage of free time.

With respect to improving the online meeting experience, consider the following. Most online meeting software utilizes a “participants list” that shows people attending the meeting. However, the list is limited to people who joined the meeting via their computers, phones or other electronic devices. These meetings often involve people physically attending from a conference room without logging into the meeting individually. Typically, one person joins the meeting and shares audio/video/content with the room using speakers and projectors which causes a suboptimal meeting experience between conference rooms that are at the two ends of the online meeting. In accordance with various embodiments, people in a particular meeting room can be identified and automatically added to a list of participants. Depending on the type of technology employed, this could include a list of people (e.g. manually signed in/signed out of the meeting or location) and/or could include identifying the people in a particular meeting's video stream (e.g., using an augmented panoramic image of the room with participant name tags if audio/facial recognition is available).

With respect to identifying gaps in individuals' schedules, consider the following. Meetings lasting shorter than the allocated time often provide the best opportunity to meet with people, especially people who are normally very busy with meetings. Since real life schedules can be very dynamic and unpredictable, meetings also need to be very flexible.

To accommodate dynamic schedules, and in accordance with one or more embodiments, a meeting request referred to herein as a “flex-meeting” request is presented. Unlike regular calendar items, some flex-meeting requests do not necessarily have set beginning and end dates or times. Rather, flex-meeting requests can have an expiration date/time. Similarly, in at least some embodiments, the location of the meeting does not have to be specified beforehand. For example, the meeting location can be set as an attendee's location—which can vary during the course of the day. As such, the inventive system uses availability data and the information (i.e. real life presence information) provided in the flex-meeting requests to help schedule meetings in a manner that utilizes an individual's time more efficiently.

In the following discussion, an example environment is first described that is operable to employ the techniques described herein. The techniques may be employed in the example environment, as well as in other environments.

Example Environment

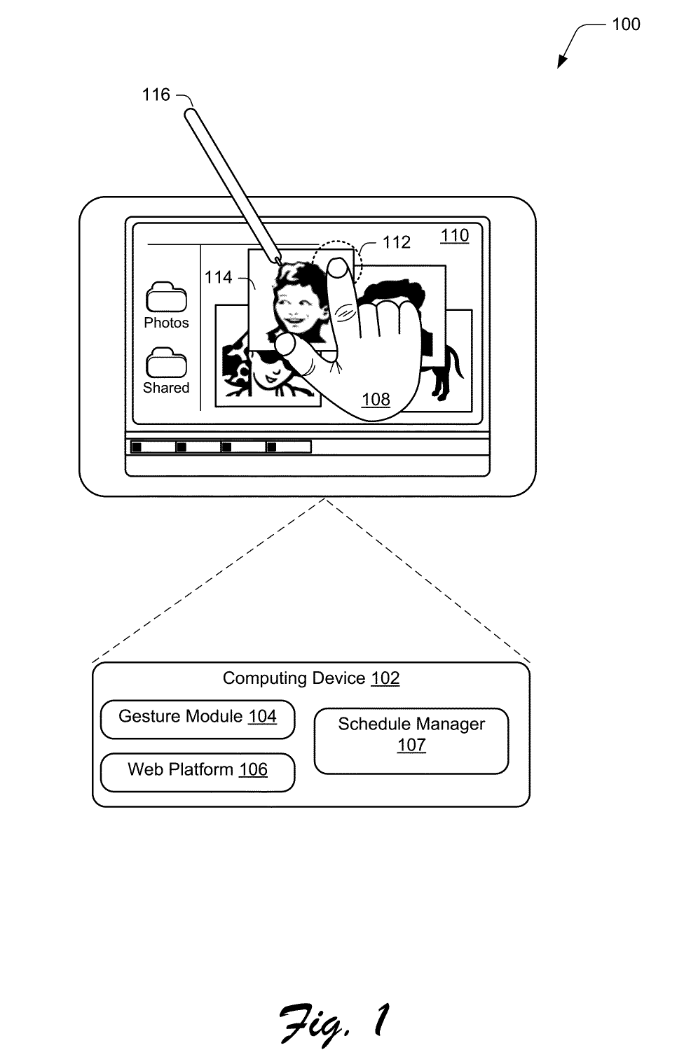

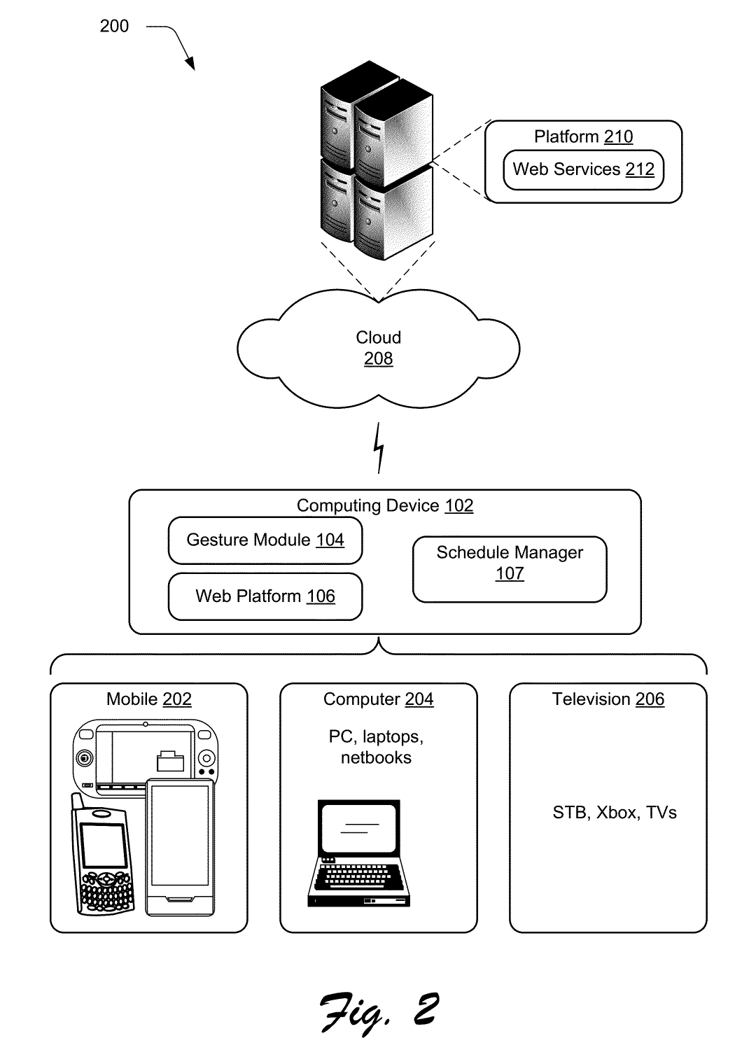

FIG. 1 is an illustration of an environment 100 in an example implementation that is operable to employ the techniques as described herein. The illustrated environment 100 includes an example of a computing device 102 that may be configured in a variety of ways. For example, the computing device 102 may be configured as a traditional computer (e.g., a desktop personal computer, laptop computer, and so on), a mobile station, an entertainment appliance, a set-top box communicatively coupled to a television, a wireless phone, a netbook, a game console, a handheld device, and so forth as further described in relation to FIG. 2. Thus, the computing device 102 may range from full resource devices with substantial memory and processor resources (e.g., personal computers, game consoles) to a low-resource device with limited memory and/or processing resources (e.g., traditional set-top boxes, hand-held game consoles). The computing device 102 also includes software that causes the computing device 102 to perform one or more operations as described below.

Computing device 102 includes a gesture module 104, a web platform 106, and a schedule manager 107.

The gesture module 104 is operational to provide gesture functionality as described in this document. The gesture module 104 can be implemented in connection with any suitable type of hardware, software, firmware or combination thereof. In at least some embodiments, the gesture module 104 is implemented in software that resides on some type of computer-readable storage medium examples of which are provided below.

Gesture module 104 is representative of functionality that recognizes gestures that can be performed by one or more fingers, and causes operations to be performed that correspond to the gestures. The gestures may be recognized by module 104 in a variety of different ways. For example, the gesture module 104 may be configured to recognize a touch input, such as a finger of a user's hand 108 as proximal to display device 110 of the computing device 102 using touchscreen functionality. For example, a finger of the user's hand 108 is illustrated as selecting 112 an image 114 displayed by the display device 110.

It is to be appreciated and understood that a variety of different types of gestures may be recognized by the gesture module 104 including, by way of example and not limitation, gestures that are recognized from a single type of input (e.g., touch gestures such as the previously described drag-and-drop gesture) as well as gestures involving multiple types of inputs. For example, module 104 can be utilized to recognize single-finger gestures and bezel gestures, multiple-finger/same-hand gestures and bezel gestures, and/or multiple-finger/different-hand gestures and bezel gestures.

For example, the computing device 102 may be configured to detect and differentiate between a touch input (e.g., provided by one or more fingers of the user's hand 108) and a stylus input (e.g., provided by a stylus 116). The differentiation may be performed in a variety of ways, such as by detecting an amount of the display device 110 that is contacted by the finger of the user's hand 108 versus an amount of the display device 110 that is contacted by the stylus 116.

Thus, the gesture module 104 may support a variety of different gesture techniques through recognition and leverage of a division between stylus and touch inputs, as well as different types of touch inputs.

The web platform 106 is a platform that works in connection with content of the web, e.g. public content. A web platform 106 can include and make use of many different types of technologies such as, by way of example and not limitation, URLs, HTTP, REST, HTML, CSS, JavaScript, DOM, and the like. The web platform 106 can also work with a variety of data formats such as XML, JSON, and the like. Web platform 106 can include various web browsers, web applications (i.e. “web apps”), and the like. When executed, the web platform 106 allows the computing device to retrieve web content such as electronic documents in the form of webpages (or other forms of electronic documents, such as a document file, XML file, PDF file, XLS file, etc.) from a Web server and display them on the display device 110. It should be noted that computing device 102 could be any computing device that is capable of displaying Web pages/documents and connect to the Internet.

Schedule manager 107 is representative of software that enables a user's schedule to be dynamically managed using the techniques described above and below.

FIG. 2 illustrates an example system showing the components of FIG. 1, e.g., schedule manager 107, as being implemented in an environment where multiple devices are interconnected through a central computing device. The schedule manager 107 can enable accurate tracking of users' statuses to provide real life presence information. The real life presence information can be used to enable meetings to be dynamically scheduled, thus making efficient use of a user's time and resources.

The central computing device may be local to the multiple devices or may be located remotely from the multiple devices. In one embodiment, the central computing device is a “cloud” server farm, which comprises one or more server computers that are connected to the multiple devices through a network or the Internet or other means.

In one embodiment, this interconnection architecture enables functionality to be delivered across multiple devices to provide a common and seamless experience to the user of the multiple devices. Each of the multiple devices may have different physical requirements and capabilities, and the central computing device uses a platform to enable the delivery of an experience to the device that is both tailored to the device and yet common to all devices. In one embodiment, a “class” of target device is created and experiences are tailored to the generic class of devices. A class of device may be defined by physical features or usage or other common characteristics of the devices. For example, as previously described the computing device 102 may be configured in a variety of different ways, such as for mobile 202, computer 204, and television 206 uses. Each of these configurations has a generally corresponding screen size and thus the computing device 102 may be configured as one of these device classes in this example system 200. For instance, the computing device 102 may assume the mobile 202 class of device which includes mobile telephones, music players, game devices, and so on. The computing device 102 may also assume a computer 204 class of device that includes personal computers, laptop computers, netbooks, tablets, and so on. The television 206 configuration includes configurations of device that involve display in a casual environment, e.g., televisions, set-top boxes, game consoles, and so on. Thus, the techniques described herein may be supported by these various configurations of the computing device 102 and are not limited to the specific examples described in the following sections.

Cloud 208 is illustrated as including a platform 210 for web services 212. The platform 210 abstracts underlying functionality of hardware (e.g., servers) and software resources of the cloud 208 and thus may act as a “cloud operating system.” For example, the platform 210 may abstract resources to connect the computing device 102 with other computing devices. The platform 210 may also serve to abstract scaling of resources to provide a corresponding level of scale to encountered demand for the web services 212 that are implemented via the platform 210. A variety of other examples are also contemplated, such as load balancing of servers in a server farm, protection against malicious parties (e.g., spam, viruses, and other malware), and so on.

Thus, the cloud 208 is included as a part of the strategy that pertains to software and hardware resources that are made available to the computing device 102 via the Internet or other networks. For example, the schedule manager 107, or aspects thereof, may be implemented in part on the computing device 102 as well as via a platform 210 that supports web services 212.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on or by a processor (e.g., CPU or CPUs). The program code can be stored in one or more computer readable memory devices. The features of the gesture techniques described below are platform-independent, meaning that the techniques may be implemented on a variety of commercial computing platforms having a variety of processors.

For example, the computing device may also include an entity (e.g., software) that causes hardware or virtual machines of the computing device to perform operations, e.g., processors, functional blocks, and so on. For example, the computing device may include a computer-readable medium that may be configured to maintain instructions that cause the computing device, and more particularly the operating system and associated hardware of the computing device to perform operations. Thus, the instructions function to configure the operating system and associated hardware to perform the operations and in this way result in transformation of the operating system and associated hardware to perform functions. The instructions may be provided by the computer-readable medium to the computing device through a variety of different configurations.

One such configuration of a computer-readable medium is a signal bearing medium and thus is configured to transmit the instructions (e.g., as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

In the discussion that follows, a section entitled “Example System” describes an example system in accordance with one or more embodiments. Next, a section entitled “Location/Presence Processing” describes how location and presence information can be acquired and managed in accordance with one or more embodiments. Following this, a section entitled “Flex-Meetings” describes various embodiments in which meetings can be flexibly scheduled in accordance with one or more embodiments. Next, a section entitled “Example Flex Meeting Properties and Characteristics” describes various properties and characteristics associated with flex meetings, in accordance with one or more embodiments. Following this, a section entitled “Notifications” describes how notifications can be generated and sent in accordance with one or more embodiments. Next, a section entitled “Name Overlays” describes name overlays in accordance with one or more embodiments. Last, a section entitled “Example Device” describes aspects of an example device that can be utilized to implement one or more embodiments.

Example System

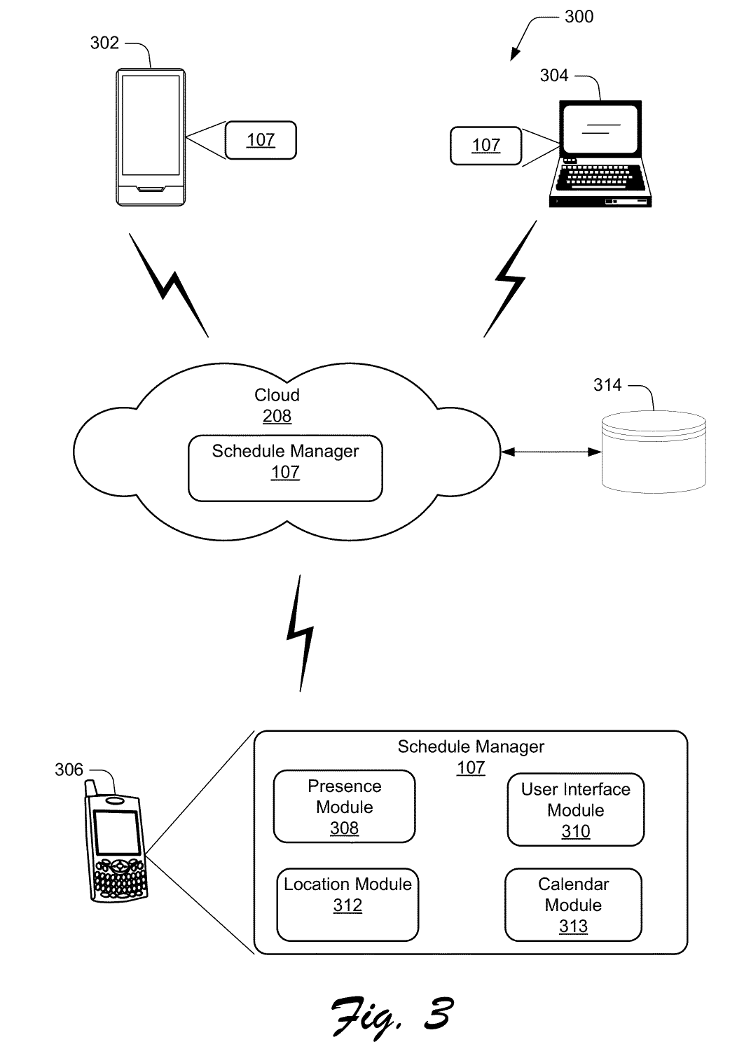

FIG. 3 illustrates an example system in accordance with one or more embodiments generally at 300. In the example about to be described, system 300 enables the real-time presence and location of various individuals to be ascertained and maintained in a data store. The data store is updated with location information and user availability. The system then uses this information to generate real-time notifications to flexibly schedule meetings to accommodate an individual's actual availability, and not just the individual cost this availability as conveyed by the individual cost this calendar, as will become apparent below.

In this example, system 300 includes devices 302, 304, and 306. Each of the devices is communicatively coupled with one another by way of cloud 208, e.g., the Internet or an Intranet. In this particular example, each device includes a schedule manager 107 which includes schedule managing functionality as described above and below. In addition, aspects of the schedule manager 107 can be implemented by cloud 208 which can utilize a suitably-configured database 314 to store information associated with users' presence information, availability, location, and meeting schedules.

In this particular example, the schedule managers resident on devices 302, 304, and 306 can include or otherwise make use of one or more of a presence module 308, a user interface module 310, a location module 312, and a calendar module 313.

In the illustrated and described embodiment, presence module 308 is representative of functionality that enables a particular user's presence information to be maintained and articulated to the cloud 208. The user can manually set their presence information or, alternatively, their presence information may be automatically ascertained by the schedule manager. Examples of presence information or status can include, by way of example and not limitation, “available”, “busy”, “away”, “do not disturb”, “in a call”, and the like.

User interface module 310 is representative of functionality that enables the user to interact with its schedule manager in order to maintain, organize, and implement their meeting schedule. The user interface module also enables notifications generated by the schedule managers to be surfaced to a respective user. For example, the user interface module can enable a notification to be surfaced to a user that indicates that a person with whom they desire to meet is now available and near their location.

Location module 312 is representative of functionality that enables a corresponding device to implement location-based functionality. For example, in at least some embodiments, the location module 312 can ascertain a particular device's location such that the location can be reported to cloud 208 for processing by a remote schedule manager 107. Alternately or additionally, the location module 312 can receive location information from third-party location providers and report the location information to the cloud 208 to enable the cloud to compute the device's location. Any suitable type of location information can be utilized to ascertain a device's location. Examples of suitable location information types are described in U.S. Pat. No. 7,363,357, assigned to the assignee of this document. Examples of location-based processing are described below.

Calendar module 313 is representative of functionality that enables the user to maintain calendar entries such as those used to organize a user's meeting schedule.

Having considered an example environment in which a schedule manager can be utilized, consider now a discussion of location/presence processing in accordance with one or more embodiments.

Location/Presence Processing

In one or more embodiments, the schedule management system implemented by schedule manager 107 utilizes advanced availability or presence capabilities described just below. In the illustrated and described embodiment, availability or presence tracking can rely on different types of technologies depending on the capabilities of a particular device or the capabilities associated with a location at which a device resides. For example, if a user's device, e.g., tablet computer, smart phone, a personal computer, is connected to a network outlet, the location module 312 can rely on IP subnet/switch information to ascertain a device's location. Alternately or additionally, if a device is connected through Wi-Fi, the device can use Wi-Fi triangulation to enable location module 312 to approximate the device's location. This information can be maintained by device 306 and provided to cloud 208 for processing by schedule manager 107. Specifically, database 314 can maintain locations of network switches, wireless access points, and the like that are populated and curated by an information technology administrator. This information can be utilized, in connection with location information received from a client device, to ascertain the device's location which, in turn, can be subsequently used for schedule management as described below in more detail. In addition, location module 312 can receive information from a user that is then used to ascertain a device's location. For example, if a user checks into a meeting, as described below, this information can be utilized to ascertain a device's location.

In one or more embodiments, the schedule manager 107 can utilize hints from sources other than those that enable a device's current physical location to be ascertained in order to disambiguate a device's location. For example, in at least some embodiments, the schedule manager 107 can utilize hints from a user's calendar, by way of calendar module 313, to ascertain a device's location, and hence an associated user's location. For example, if a user's calendar indicates that the user is supposed to be in a meeting in a particular conference room—e.g., conference room A, and the location module 312 identifies, by way of Wi-Fi triangulation, two potential nearby conference rooms—e.g., conference room A and conference room B, the schedule manager can automatically sign the user into the meeting listed in the user's calendar in the appropriate conference room—conference room A. This information can then be provided to the cloud 208 and maintained in database 314 for subsequent use in scheduling flex-meetings. That is, in this instance, the schedule manager 107 is able to utilize location information associated with a device's location and calendar information associated with calendar module 313 to disambiguate a device's or user's location.

With respect to ascertaining a device's location, consider the following. As noted above, the schedule manager 107, through the location module 312, can utilize a number of different technologies to ascertain a device's location. The schedule manager can rely on a number of different location providers to provide information from which a device's location can be ascertained. For example, the schedule manager can utilize GPS, cell identification/signal strength/round trip time, and various other types of technologies, such as those described in U.S. Pat. No. 7,363,357. For example, location providers can include, by way of example and not limitation, a location user interface in which a user enters their location, various location beacons which transmit location information, various wireless approaches as noted above including IEEE 802.11 AP, and the like.

These approaches to ascertaining a device's location need not necessarily be used alone. Rather, the schedule manager can use multiple different types of location technologies to ascertain a device's location. For example, the schedule manager might employ both GPS and Wi-Fi location providers to ascertain the location with a finer degree of granularity.

As a further example, if a user's device supports Near Field Communication (NFC), then the user can sign into a particular location, such as a meeting or meeting room, using an NFC reader by swiping or scanning NFC tags with their device. NFC, as will be appreciated by the skilled artisan, pertains to a set of standards by which devices may establish radio communication with each other by bringing them into physical proximity as by touching them together. This can permit contact-less transactions, data exchange and simplified setup of more complex communications such as Wi-Fi communications.

In one or more embodiments, a user's location or presence can be ascertained automatically in connection with a meeting in which they are in attendance. For example, if the meeting takes place in a meeting room that includes a camera that captures images of people in the meeting room and a microphone, facial recognition and/or voice recognition can be utilized to detect users in the room. Facial or voice recognition techniques typically rely on a user's previous phone or video calls, or pictures (such as that from a user profile) as training data. This training data can then be utilized to identify particular users who may be present in the meeting room. Any suitable type of face recognition technology can use used, examples of which are described in U.S. Pat. No. 8,494,231, assigned to the assignee of this document. Examples of voice recognition technology are described in U.S. Pat. No. 7,428,491, assigned to the assignee of this document.

Once the participants have been identified, through whatever means, this information can be provided to cloud 208 to be stored in database 314, thus allowing confirmed ways for users to check into a particular meeting. Alternately or additionally, images or voice information can be provided to cloud 208 and a schedule manager located in the cloud can ascertain the associated individuals.

Having considered various aspects of location and presence processing, consider now how this information can be used to implement flexible meetings or “flex-meetings”.

Flex-Meetings

In one or more embodiments, when a user signs into a meeting, their status is set to “busy” meaning that the user is not available to meet. This information can be conveyed to the cloud 208 as described above. If the meeting has an online component, the user can be added to a list of participants. Depending on the type of technology utilized, this can include identifying people in a video stream, as described above, and/or using audio recognition technology, to name just a few. When the user signs out of the meeting, their status is set to “free” meaning that they are now available to meet. Again, this information can be conveyed to the cloud 208 as described above. If the meeting has an online component, the user can then be removed from the list of participants. Using this location or presence information, the system can schedule flex meetings. As an example, consider the following.

Many communication or schedule-type applications define calendar unavailability as periods of time blocked by scheduled events in a user's calendar during, for example, working hours. However, the fact that a user has accepted a particular scheduled meeting request does not necessarily mean he or she will attend the meeting. Even if the user does opt to attend the meeting, the specified time in the user's calendar for the meeting rarely matches the actual length of the meeting. That is, very often meetings last for a shorter or longer duration than originally planned. While the user is in the meeting, their presence status may be “unavailable”. Of course, a user's unavailability is not limited to being in a meeting or conference room. For example, a user could be having lunch at his or her workplace cafeteria and, as such, be unavailable for a meeting. Similarly, the fact that a user defines his or her workday as occurring between 9 a.m. and 5 p.m. does not necessarily mean that he or she will be arriving and leaving at those times. People may arrive earlier or later than their typical 9-to-5 schedule dictates. Using the techniques described above and below, various embodiments can capture the actual user's availability or unavailability for these and other cases including, by way of example and not limitation, the type of availability, e.g., available for online/dial-in conferencing, but not for in person conferencing.

Because real life schedules are very dynamic, taking advantage of unexpected openings in a person's schedule means that meetings are scheduled in a flexible manner in accordance with one or more embodiments—i.e., flex meetings. As will become apparent below, presence and/or location information, as described above, can be used to trigger reminders related to scheduling flex meetings. For example, if a user has a particular queue of people that they need to meet with during the day, and their in-progress meeting ends early, by having an awareness of where the user is and their presence, as well as where their associated queue of people are located, the schedule manager 107 can generate a trigger to one or more of the people in the queue in an attempt to enable a flex meeting to be scheduled. For example, the system may recognize that two users who desire to meet have unexpectedly become free and are located in close proximity. The system may then generate a trigger to both users to enable them to schedule a flex meeting.

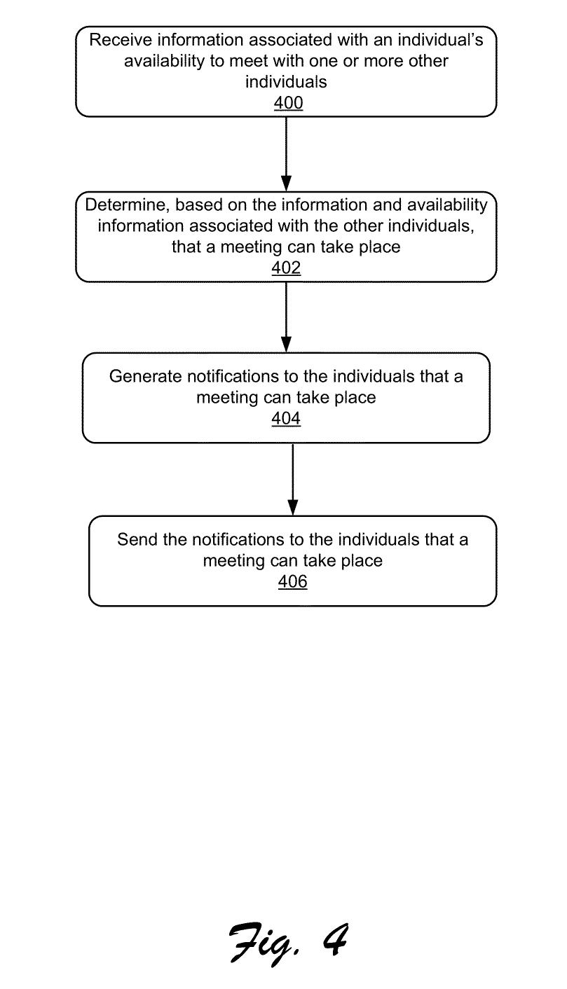

FIG. 4 is a flow diagram that describes steps in a method in accordance with one or more embodiments. The method can be implemented in connection with any suitable hardware, software, firmware, or combination thereof. In one or more embodiments, aspects of the method can be implemented by a suitably-configured schedule manager such as those described above and below.

Step 400 receives information associated with an individual's availability to meet with one or more other individuals. The received information can comprise any suitable type of information. For example, in at least some embodiments the information comprises presence information and/or location information associated with a particular individual. Step 402 determines, based on the information and availability information associated with the other individuals, that a meeting can take place. In at least some embodiments, this step can be performed by maintaining availability information associated with the other individuals. Examples of availability information include, by way of example and not limitation, presence information and/or location information. The availability information for these individuals can be monitored and regularly updated as described above and below. Step 404 generates notifications to the individuals that a meeting can take place. Any suitable notification can be generated in any suitable channel can be used to provide the notifications to the individuals. Step 406 sends the notifications to the individuals that a meeting can take place.

Once the individuals receive this information, they can go about scheduling their meeting in any suitable manner, e.g., online, in-person, teleconference, video phone call, and the like.

Having considered an example method in accordance with one or more embodiments, consider now some example flex meeting properties and characteristics.

Example Flex Meeting Properties and Characteristics

In one or more embodiments, flex meetings can have properties and characteristics that facilitate flexible scheduling. For example, unlike regular calendar items, in at least some embodiments, flex meeting requests may not have set beginning and end dates or times. Rather, a flex meeting request sent by one user to another may simply specify that they desire to meet before a particular expiration date and/or time. Similarly, in at least some embodiments, flex meetings may not necessarily have a pre-specified, fixed location. In at least some embodiments, when flex meeting requests are sent to other users, a similar request can be sent to a cloud-based schedule manager so that the schedule manager can use the users' presence and/or location information to attempt to flexibly schedule a meeting.

For example, a first user may send a second user (and the cloud-based schedule manager) a flex meeting request that specifies an expiration date and a location as the second user's location. As the second user's location changes during the course of the day, the location is not a fixed location. Thus, in this instance, the actual meeting location may be one in which the first and second user find themselves in close physical proximity. Alternately or additionally, the actual meeting location may depend on conference room availability at a time when the first and second users find themselves in close physical proximity. The schedule manager 107 uses each user's presence and location information, as well as information provided in the flex meeting request to help schedule meetings in a manner that efficiently uses each users' time.

For example, assume that the first user is trying to connect with a second user who is extremely busy. The second user's calendar may represent that the second user is completely booked for the whole week. If the first user were to simply use their insight into the second user's calendar in a vacuum, they may be forced to schedule a meeting three or four weeks away. In a situation where the first user only wished for a 15 minute window to meet, it might have been possible to get an earlier meeting given the fact that the second user's availability dynamically changes. As an alternative, consider a situation in which the first user sends the second user a flex meeting request that specifies that they wish to meet with the second user by this-coming Friday. The first user might also, in the flex meeting request, specify a duration, e.g., 15 minutes. The flex meeting request sent by the first user can be sent to not only the second user but also the schedule manager in the cloud 208. Now, by maintaining presence and location information associated with both users, the schedule manager in the cloud 208 can trigger notifications to both users when the second user's availability changes in a manner that would accommodate a 15-minute meeting.

In accordance with one or more embodiments, the flex meeting or flex meeting request can include other properties such as, by way of example and not limitation, required or optional attendees, location (physical, online, video phone call, or virtual), title, description, approximate duration, priority and/or optional “finalize by” date/time. In this manner, recipients of a flex meeting request can view outstanding meeting requests and prioritize them either manually or by defining a set of rules for automatic classification. Prioritization can take place using any suitable criteria. In addition, in at least some embodiments, prioritization of flex meeting requests is not disclosed to the requester. When the recipient of the flex meeting request is available, for example, having walked out of the meeting, he or she can be presented, via their computing device, a list of meeting requests ordered by their expiration dates/times, priority, and participant availability. He or she may then pick a meeting of choice and the requester or other invited attendees can receive notifications which they can then accept or deny. Recipients can view the list of outstanding requests at any time and sort or filter as they wish.

Other properties or characteristics of a flex meeting or flex meeting request can be that the flex meeting is booked through a negotiation process. For example, assume that a user receives a flex meeting request that specifies an expiration date or time. That user can begin a negotiation by returning with a start date or time. That is, perhaps the recipient of the flex meeting requests is busy but knows that their availability may free up in two days. In this case, the recipient may return with a start date or time of two days in the future with the flex meeting having an expiration date or time as originally specified. In this manner, the recipient of the flex meeting request can tighten an associated meeting window to more closely fit their availability schedule.

In one or more embodiments, flex meetings can also be used for scheduling meetings in the distant future by taking advantage of a so-called “finalize by” date or time. For example, if a meeting A is to take place within the next month, but meeting B is to take place tomorrow, the schedule manager can reschedule meeting A to make room for meeting B. However, the date/time and location of the meeting does not change after the “finalize by” date to give room for attendees to prepare for the meeting. For example, if meeting logistics are to be finalized within seven-days' notice, when the meeting is six days away from the scheduled date, based on the “finalize by” date, the logistics are locked and are not updated by the schedule manager. The system can then automatically try to find spots that work for all the participants and if none are available, can double-book a time slot expecting that a participant will react by either freeing that spot or declining the request or proposing a new time.

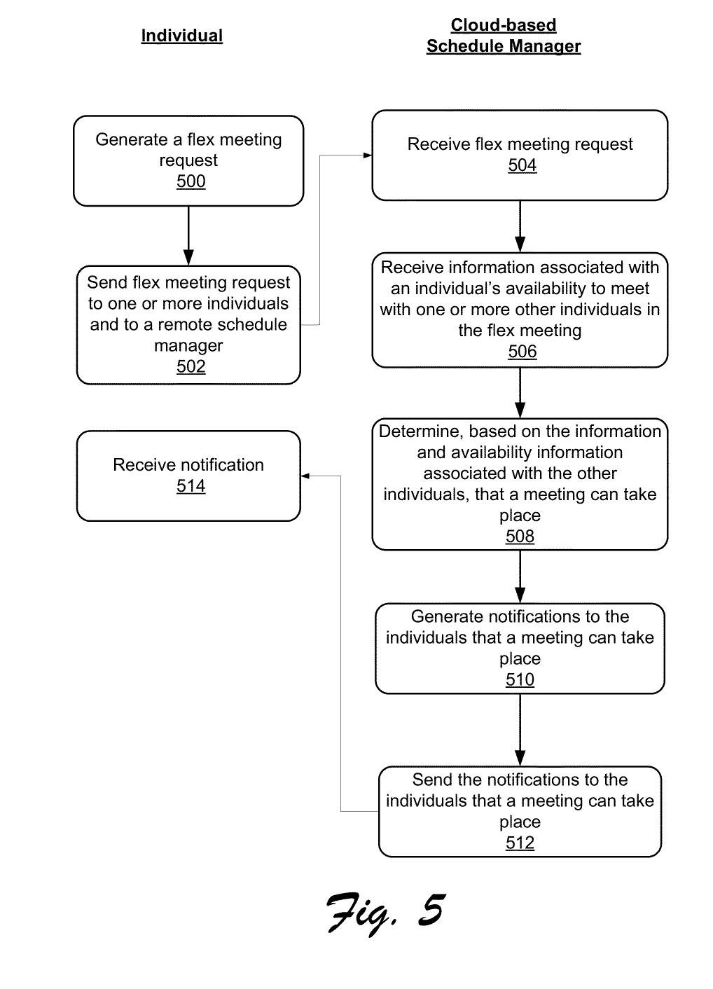

FIG. 5 is a flow diagram that describes steps in a method in accordance with one or more embodiments. The method can be implemented in connection with any suitable hardware, software, firmware, or combination thereof. In one or more embodiments, aspects of the method can be implemented by a suitably-configured schedule manager such as those described above and below. In this particular example, aspects of the method can be performed on behalf of an individual by their client computing device, and other aspects can be performed by a remote schedule manager, such as a cloud-based schedule manager.

Step 500 generates a flex meeting request. Examples of characteristics and properties of flex meeting requests are described above. Step 502 sends the flex meeting request to one or more individuals as well as to a remote schedule manager.

Step 504 receives the flex meeting request. This step can be performed by receiving the request and entering associated information into a suitably-configured database such as, by way of example and not limitation, intended participants and meeting parameters such as meeting expiration date or time, as well as other optional parameters. Step 506 receives information associated with an individual's availability to meet with one or more other individuals in the flex meeting. The received information can comprise any suitable type of information. For example, in at least some embodiments the information comprises presence information and/or location information associated with a particular individual. Step 508 determines, based on the information and availability information associated with the other individuals, that a meeting can take place. In at least some embodiments, this step can be performed by maintaining availability information associated with the other individuals. Examples of availability information include, by way of example and not limitation, presence information and/or location information. The availability information for these individuals can be monitored and regularly updated as described above and below. In at least some embodiments, meetings can be scheduled by using time portions from a meeting that is already scheduled for an individual in advance. When this happens, a notification can be sent to the original meeting requester notifying them that a requested meeting has been shortened for that particular party receiving the meeting request. In essence, this allows individuals to partially accept meetings. Step 510 generates notifications to the individuals that a meeting can take place. Any suitable notification can be generated and any suitable channel can be used to provide the notifications to the individuals. In at least some instances, these notifications can include one or more notifications of a partially accepted meeting. Step 512 sends the notifications to the individuals that a meeting can take place.

Step 514 receives the notification generated by the remote schedule manager. Once the individuals receive this information, they can go about scheduling their meeting in any suitable manner, e.g., online, in-person, teleconference, video phone call, and the like.

Having considered various embodiments of flex meetings, consider now a discussion of how schedule manager 107 can generate and send notifications.

Notifications

In one or more embodiments, the schedule manager 107, for example the schedule manager in cloud 208, maintains a list of users, associated devices of the users, and device capabilities, and uses this information to select a way to notify other users based on available options and urgency. For example, if the meeting is going to start in five minutes and an attendee is active on their instant messaging client endpoint, the meeting notification can be sent over instant messaging. If, on the other hand, instant messaging is not available, the meeting notification can be sent over text message (e.g. SMS). If, on the other hand, the meeting is to happen in four days with less urgency, a meeting notification can be sent by e-mail.

In this manner, the system can be said to select an appropriate notification type that is calculated to provide user notifications in a manner commensurate with the urgency or timeliness of the meeting.

Name Overlays

In one or more embodiments, participants in a meeting room can be identified using facial recognition technology, as noted above. For meetings, such as video meetings that take place in multiple locations, participants who are identified using facial recognition technology can have a name tag overlay placed adjacent their picture when they appear on transmitted video.

Having described methods and systems for real life presence and dynamic meeting scheduling, consider now an example device that can be utilized to implement one or more embodiments described above.

Example Device

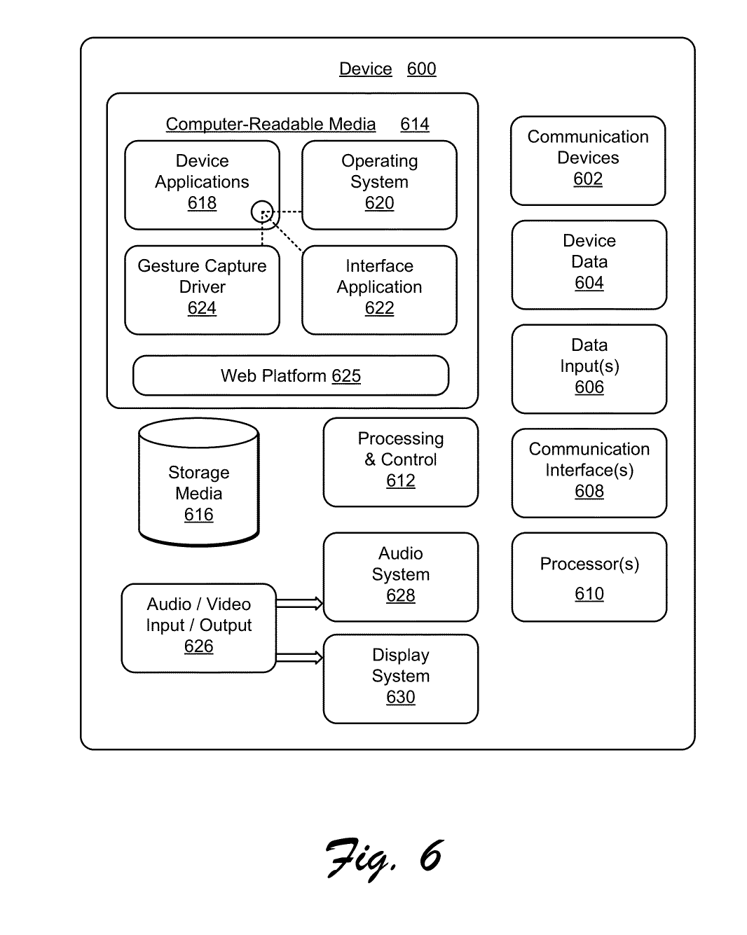

FIG. 6 illustrates various components of an example device 600 that can be implemented as any type of computing device as described with reference to FIGS. 1 and 2 to implement embodiments of the techniques described herein. Device 600 includes communication devices 602 that enable wired and/or wireless communication of device data 604 (e.g., received data, data that is being received, data scheduled for broadcast, data packets of the data, etc.). The device data 604 or other device content can include configuration settings of the device, media content stored on the device, and/or information associated with a user of the device. Media content stored on device 600 can include any type of audio, video, and/or image data. Device 600 includes one or more data inputs 606 via which any type of data, media content, and/or inputs can be received, such as user-selectable inputs, messages, music, television media content, recorded video content, and any other type of audio, video, and/or image data received from any content and/or data source.

Device 600 also includes communication interfaces 608 that can be implemented as any one or more of a serial and/or parallel interface, a wireless interface, any type of network interface, a modem, and as any other type of communication interface. The communication interfaces 608 provide a connection and/or communication links between device 600 and a communication network by which other electronic, computing, and communication devices communicate data with device 600.

Device 600 includes one or more processors 610 (e.g., any of microprocessors, controllers, and the like) which process various computer-executable instructions to control the operation of device 600 and to implement embodiments of the techniques described herein. Alternatively or in addition, device 600 can be implemented with any one or combination of hardware, firmware, or fixed logic circuitry that is implemented in connection with processing and control circuits which are generally identified at 612. Although not shown, device 600 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 600 also includes computer-readable media 614, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 600 can also include a mass storage media device 616.

Computer-readable media 614 provides data storage mechanisms to store the device data 604, as well as various device applications 618 and any other types of information and/or data related to operational aspects of device 600. For example, an operating system 620 can be maintained as a computer application with the computer-readable media 614 and executed on processors 610. The device applications 618 can include a device manager (e.g., a control application, software application, signal processing and control module, code that is native to a particular device, a hardware abstraction layer for a particular device, etc.). The device applications 618 also include any system components or modules to implement embodiments of the techniques described herein. In this example, the device applications 618 include an interface application 622 and a gesture capture driver 624 that are shown as software modules and/or computer applications. The gesture capture driver 624 is representative of software that is used to provide an interface with a device configured to capture a gesture, such as a touchscreen, track pad, camera, and so on. Alternatively or in addition, the interface application 622 and the gesture capture driver 624 can be implemented as hardware, software, firmware, or any combination thereof. Additionally, computer readable media 614 can include a web platform 625 that functions as described above.

Device 600 also includes an audio and/or video input-output system 626 that provides audio data to an audio system 628 and/or provides video data to a display system 630. The audio system 628 and/or the display system 630 can include any devices that process, display, and/or otherwise render audio, video, and image data. Video signals and audio signals can be communicated from device 600 to an audio device and/or to a display device via an RF (radio frequency) link, S-video link, composite video link, component video link, DVI (digital video interface), analog audio connection, or other similar communication link. In an embodiment, the audio system 628 and/or the display system 630 are implemented as external components to device 600. Alternatively, the audio system 628 and/or the display system 630 are implemented as integrated components of example device 600.

### CONCLUSION

Various embodiments provide solutions that enable accurate tracking of users' statuses to provide real life presence information. The real life presence information can be used to enable meetings to be dynamically scheduled, thus making efficient use of a user's time and resources.

Although the embodiments have been described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A computer-implemented method comprising:
receiving information associated with an individual's availability to meet with one or more other individuals;
determining, based on the information and availability information associated with the one or more other individuals, that a meeting can take place;
generating notifications to the individual and the one or more other individuals that a meeting can take place; and
sending the notifications to the individual and the one or more other individuals that a meeting can take place.

2. The method of claim 1, wherein the information and availability information comprise one or more of presence information or location information.

3. The method of claim 1, wherein said receiving, determining, generating, and sending are performed by a cloud service.

4. The method of claim 1, wherein said receiving information is performed by receiving information from multiple different providers.

5. The method of claim 1, wherein said receiving information comprises receiving at least some information from a source other than one that enables a device's current physical location to be ascertained and said determining comprises using said at least some information to ascertain a device's location.

6. The method of claim 1, wherein said receiving information comprises receiving information entered by the individual into an associated device.

7. The method of claim 1, wherein said receiving information comprises receiving images or voice information of one or more individuals.

8. One or more computer readable storage media having instructions stored thereon that, responsive to execution by a computing device, cause the computing device to perform operations comprising:
receiving a meeting request from an individual that specifies one or more other individuals with whom a meeting is desired;
receiving information associated with the individual's availability to meet with the one or more other individuals;
determining, based on the information and availability information associated with the one or more other individuals, that a meeting can take place;
generating notifications to the individual and the one or more other individuals that a meeting can take place; and
sending the notifications to the individual and the one or more other individuals that a meeting can take place.

9. The one or more computer readable storage media of claim 8, wherein the meeting request does not include a set time for the meeting to begin or a set time for the meeting to end.

10. The one or more computer readable storage media of claim 8, wherein the meeting request includes an expiration date or time before which the meeting is to take place.

11. The one or more computer readable storage media of claim 8, wherein the meeting request does not include a fixed location at which the meeting is to take place.

12. The one or more computer readable storage media of claim 8, wherein the meeting request specifies, as a location, the location of one of the individuals.

13. The one or more computer readable storage media of claim 8 further comprising receiving, from at least one of the one or more other individuals, information to begin a negotiation to book the meeting.

14. The one or more computer readable storage media of claim 8, wherein said sending is performed by selecting a notification type that is calculated to provide notifications in a manner commensurate with a meeting's timing.

15. A device comprising:
one or more processors;
one or more computer readable media storing computer readable instructions which, when executed, implement a schedule manager configured to enable presence information and location information associated with multiple individuals to be utilized to book a meeting, the meeting being specified by a meeting request that includes one or more of an expiration date or time before which the meeting is to take place and not being specified, in the meeting request, by a set time for the meeting to begin or a set time for the meeting to end.

16. The device of claim 15, wherein the device comprises a client computing device.

17. The device of claim 15, wherein the device comprises a cloud server.

18. The device of claim 15, wherein the location information comprises location information from multiple different location providers.

19. The device of claim 15, wherein the meeting request does not include a fixed location at which the meeting is to take place.

20. The device of claim 15, wherein the meeting request specifies, as a location, the location of one of the individuals.
